(19) United States
(12) Patent Application Publication
(10) Pub. No.: US 2006/0137723 A1
(43) Pub. Date: Jun. 29, 2006

(54) Workpiece processing using ozone gas and solvents

(76) Inventor: Eric J. Bergman, Kalispell, MT (US)

Correspondence Address: PERKINS COIE LLP/SEMITOOL, PO BOX 1208, SEATTLE, WA, 98111-1208, US

(21) Appl. No.: 11/354,642

(22) Filed: Feb. 15, 2006

Related U.S. Application Data
(63) Continuation-in-part of application No. 09/925,884, filed on Aug. 6, 2001.
Application No. 09/925,884 is a continuation-in-part of application No. 09/621,028, filed on Jul. 21, 2000, now Pat. No. 6,869,487.
Application No. 09/621,028 is a continuation-in-part of application No. PCT/US99/08516, filed on Apr. 16, 1999.
Application No. PCT/US99/08516 is a continuation-in-part of application No. 09/061,318, filed on Apr. 16, 1998, now abandoned.
Application No. 09/061,318 is a continuation-in-part of application No. 08/853,649, filed on May 9, 1997, now Pat. No. 6,240,933.

(51) Int. Cl. B08B 3/00

(52) U.S. Cl. 134/34; 134/36; 134/94.1; 134/105

(57) ABSTRACT

In systems and methods for cleaning a wafer having metal areas, a non-aqueous polar solvent solution is applied onto the wafer, while the wafer is also contacted by ozone gas. The solvent helps to make the chemical bonds of contaminants on the wafer susceptible to oxidation by the ozone. The ozone readily oxidizes the contaminants in the presence of the solvent. The solvent provides a liquid medium for carrying away oxidized contaminants or by products. Corrosion of metal on the wafer is minimized or eliminated as the solvent helps to control the level of ions and galvanic cell effects. Higher process temperatures may be used to accelerate the cleaning process, without causing corrosion.

This application is a Continuation-in-Part of U.S. patent application Ser. No. 09/925,884, filed Aug. 6, 2001 and now pending, which is a Continuation-in-Part of application Ser. No. 09/621,028, filed Jul. 21, 2000, now U.S. Pat. No. 6,869,487, which is a Continuation-in-Part and U.S. National Phase of International Application No. PCT/US99/08516, filed Apr. 16, 1999, (designating the United States and published in English), which is a Continuation-in-Part of Ser. No. 09/061,318, filed Apr. 16, 1998, now abandoned, which is a Continuation-in-Part of: Ser. No. 08/853,649, filed May 9, 1997, now U.S. Pat. No. 6,240,933. Priority to each of these application is claimed. The above listed applications are also incorporated herein by reference.

### BACKGROUND OF THE INVENTION

Microelectronic semiconductor devices are essential in modern day life. These devices are used in electronic products, computers, automobiles, cell phones, and a vast array of communications, medical, industrial, military, and office products and equipment. Microelectronic semiconductor devices are manufactured from semiconductor wafers. Typically, these devices may be just fractions of a micron, with thousands of devices manufactured on a single wafer. Correspondingly, microelectronic devices are highly susceptible to performance degradation or failure due to contamination by even microscopic particles, films and process residues.

Microelectronic devices generally are made of semiconductor materials, such as silicon, and also conductor materials, such as metals like aluminum and copper. Ordinarily, manufacturing microelectronic devices requires a large number of steps, with layers of materials selectively applied and removed from the wafer. The wafer usually must be cleaned between various steps, to insure that any remaining process chemicals, residues, films or particles (collectively referred to here as contaminants) are removed. Consequently, wafer cleaning is a critical step in the manufacturing process.

For many years, wafers were cleaned in typically three or four separate steps using strong acids, such as sulfuric acid, and using strong caustic solutions, such as mixtures of hydrogen peroxide or ammonium hydroxide. Organic solvents have also been used with wafers having metal films. These methods had certain disadvantages, including the high cost of the process chemicals, the relatively long time required to get wafers through the various cleaning steps, high consumption of water due to the need for extensive rinsing between chemical steps, and high disposal costs. As a result, extensive research and development efforts focused on finding better wafer cleaning techniques.

Several years ago, the Inventor developed a revolutionary new process for cleaning wafers using ozone gas and heated water (or water vapor). This process, described in its basic form in Applications listed in paragraph 0001 above has proven to be highly effective in cleaning contamination and organic films, while avoiding many of the disadvantages of the traditional cleaning methods. More recently, the semiconductor manufacturing industry has acknowledged the advantages of the ozone gas and heated water process. Some of the advantages of this ozone process are that it is fast, requires no expensive and toxic liquid acids or caustics, and operates effectively as a spray process, which greatly reduces water consumption and space requirements.

Certain metals that are commonly used on semiconductor wafers can corrode when exposed to ozone and heated water. As the process temperatures increase, the chemical reaction rate of all reactions, including metal corrosion, also increases. Dissimilar metals in ohmic contact with each other can also create a galvanic cell potential or electrical interaction which may promote corrosion.

Several methods have been proposed for reducing or avoiding corrosion. These methods typically include reducing the process temperature and/or using additives that include various corrosion inhibitors. Reducing the temperature is generally undesirable because it slows down the reaction rates of the chemicals acting to remove the organic films or contaminants from the workpiece. Corrosion inhibitors, which generally include additives such as nitrates, silicates, and benzo triazole, have been relatively effective at reducing corrosion on predominantly aluminum films. The application of these inhibitors with the ozone and heated water cleaning techniques has allowed use of higher process temperatures, to achieve higher cleaning or strip rates, while substantially controlling corrosion of aluminum surfaces on the wafers.

Still, use of corrosion inhibitors can be disadvantageous as it involves using an additional chemical or additive. The corrosion inhibitors must also be appropriately mixed with the heated water. More importantly, their effectiveness can vary with different metals and other process parameters. Accordingly, there is a need for better methods for efficiently cleaning semiconductor wafers, while also preventing corrosion of metals on the wafers.

### SUMMARY OF THE INVENTION

The Inventor of the ozone gas and heated water process has now also solved the metal corrosion problems described above. In a new process taking an entirely unconventional approach, ozone gas is used with a liquid containing little or no water. Rather, a non-aqueous polar liquid or solvent is used with ozone gas. Use of the non-aqueous solvent reduces the presence of leading corrosion causing factors, specifically, ions and galvanic cell electrical potentials. By reducing or removing these factors, corrosion of metals on the wafers is largely avoided. In this new process, several of the advantages of the successful ozone gas and heated water process are retained, while also overcoming the challenges presented by corrosion.

The invention resides as well in sub-combinations of the features, components, steps, and subsystems shown and described. The optional steps described in one embodiment or shown in one drawing may apply equally to any other embodiment or drawing.

### BRIEF DESCRIPTION OF THE DRAWINGS

In the drawings, wherein the same reference number indicates the same element in each of the Figures:

FIG. 1 is a diagram of a system for cleaning a workpiece, such as a semiconductor wafer, with ozone injected or bubbled into the liquid.

FIG. 2 is a diagram of a system for cleaning a batch of workpieces.

FIG. 3 is a diagram of a system for cleaning a workpiece using ozone gas and a liquid, with the ozone supplied into the processing chamber, rather than into the liquid as shown in FIG. 1.

FIG. 4 is a diagram of a system for cleaning a workpiece using a vapor and ozone gas.

FIG. 5 is a diagram of a system similar to the system of FIG. 3, with liquid applied to the workpiece from a nozzle on a swing arm, optionally in the form of a jet.

While showing preferred designs, the drawings include elements which may or may not be essential to the invention. The elements essential to the invention are set forth in the claims. Thus, the drawings include both essential and non-essential elements.

### DETAILED DESCRIPTION OF THE DRAWINGS

The terms workpiece, wafer or semiconductor wafer are defined here to include any flat media or article, including a semiconductor wafer or other wafer or substrate, glass, mask, optical, disk, or memory media, flat panel displays, MEMs substrates, and any other substrates upon which microelectronic circuits or components, data storage elements, and/or micro-mechanical, or micro-electromechanical elements are or can be formed. The term solvent or non-aqueous solvent here means any non-aqueous polar liquid, optionally including some water, and/or other additives or components.

In a method for cleaning a wafer having a metal area, feature or layer, a non-aqueous polar solution or solvent is applied onto the wafer, while the wafer is also contacted by ozone gas. The solution helps to make the chemical bonds of the contaminant susceptible to oxidation by the ozone. The ozone readily oxidizes the contaminants in the presence of the solution. The solution also provides a liquid medium for carrying away oxidized contaminants or by products. Corrosion of metal on the wafer is minimized or eliminated as the solution helps to control the level of ions and galvanic cell effects.

The method may be performed at sub-ambient temperatures (for example 0-20° C.), at ambient temperatures (near 20° C.), or at higher temperatures. In general, the temperature of the solvent may range for about 0° C. up to just below the boiling point of the solvent, or the solvent solution (where other liquid components are included with the solvent). The solvent may be heated or cooled to these temperatures. The wafer may also be separately heated by contact or radiant heating elements in the chamber.

The chamber may be at ambient pressure, since neither above or below ambient pressures are needed. Depending on the solvent used, the contamination to be removed, or other factors, above or below ambient chamber pressures may be used. For example, chamber pressure may be increased over ambient pressure by, e.g., 10%, 20%, 30%, or 50-100% or 200%, or higher.

The method may be performed in a single wafer mode, by processing a single wafer within a process chamber. The method may also be performed in a group or batch mode, with multiple wafers processed simultaneously within a single batch processing chamber. In general, it is helpful to spin the wafers during processing. Spinning helps to distribute the solvent on the wafer surface, and also helps to maintain a flow of solvent off the edges of the wafer, via centrifugal force. The flow of solvent carries away oxidized contaminants, and tends to maintain a supply of fresh solvent on the wafer. Spinning may also be used to form the solvent into a thin layer on the wafer. Ozone gas in the chamber can then more easily diffuse through the layer of solvent to the wafer surface, to oxidize contaminants on the surface. However, the present methods may also be performed without spinning. The orientation of the wafer(s) during processing, or the orientation of the spin axis (if spinning is used) is not essential.

Various non-aqueous solvents may be used. These include organic acids, alcohols and aldehydes. Low molecular weight acids may be used, including formic acid, acetic acid, phosphoric acid, malonic acid, sulfuric acid or propionic acid. Alcohols such as isopropyl alcohol, methanol, ethanol, or propanol may also be used. Organic solvents such as n-methyl pyrolidone, or halogenated hydrocarbons may also be used. These compounds may also be mixed. Small amounts of water, e.g., up to about %5, %10, %15, %20or even %25may be included. The word non-aqueous solvent, or solvent, as used here, accordingly includes liquids containing some water. The solvent advantageously has a molecular structure including at least one polar group. Additives such as HF and NH3 may be included in the solvent.

The solvent may be applied by spraying, flowing, streaming, jetting, condensing, or immersion. The solvent may be applied to one or both sides of the wafer. In a condensing method, a solvent vapor is provided into the chamber. The solvent vapor then condenses on the wafer. The solvent may be applied to either an up-facing side of the wafer, or to a down-facing side of the wafer, or to both. Process times will vary depending on the contamination to be removed, process temperatures, and other parameters. The invention contemplates use of ozone gas and a non-aqueous polar liquid or solvent, regardless of how each of these elements is provided into the chamber.

The ozone gas may be provided as dry gas sprayed, jetted, pumped or otherwise introduced into the chamber. The ozone gas may also be mixed into or entrained with the liquid solvent. In this design, some of the ozone may be dissolved into the gas, with other fractions of the ozone gas entrained as gas bubbles in the liquid. A combination of dry gas injection and injection into liquid may also be used.

The process is effective for removing various types of contaminants and films, such as photoresist, post etch residue, and other organic substances. Although aluminum and copper are most often used on wafers, the present methods are also useful for wafers having other metals as well. The present methods can be especially useful with copper, since corrosion inhibitor additives are often less effective in stopping corrosion of copper by ozone and heated water. The form of the metal areas on the wafer (e.g., contacts, lines, vias, pads, etc.) is generally not important as the wafer is cleaned with little or no corrosion of any of the metal areas. Following the cleaning process, the wafer may be dried directly. Alternatively, in some applications, the wafer may be rinsed with water or a water solution, and then dried.

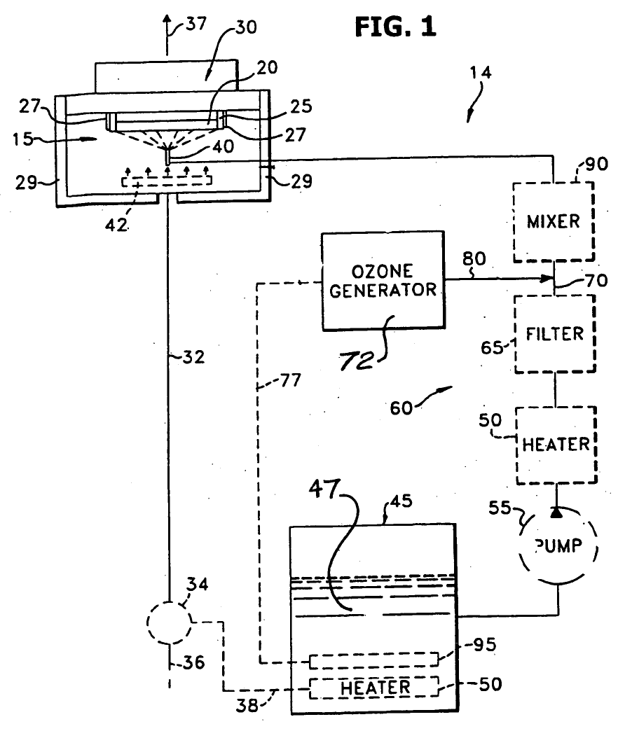

The drawings show representative examples of systems that may be used to clean wafers. Dotted lines in the drawings indicate optional elements that may be omitted. One or more of the systems shown in the Figures may be used in an automated processing machine, wherein wafers are loaded and unloaded via a robot, such as described in U.S. Pat. Nos. 6,900,132 and 6,723,174. Turning now to FIG. 1, in a single workpiece processing or cleaning system 14, a wafer or workpiece 20 is preferably supported within a processing chamber 15 on a rotor assembly 30. A chamber door closes off or seals the chamber 15. The rotor assembly 30 spins the, workpiece 20 about a spin axis 37 during and/or after processing with ozone and a non-aqueous solvent. The spin axis 37 is preferably vertical, although it may alternatively have other orientations. Alternatively, a stationary fixture may be used in the chamber 15 for non-spinning methods. The wafer 20 may be secured to the rotor assembly 30 using mechanical elements such as fingers, pins, levers, cams, etc.

If the volume of the processing chamber 15 is minimized, ozone gas consumption may be reduced. In a single wafer processor, typical chamber volumes may range from about 3-10, 4-8 or 5-6 liters. One or more outlets or nozzles 40 in the processing chamber 15 direct a spray or stream of ozone gas and liquid solvent onto the workpiece 20. The spray may be directed to the upper or lower surface of the workpiece 20, or both.

A reservoir 45 or tank preferably holds the liquid solvent 47. The reservoir 45 may be connected to the input of a pump 55. The pump 55, if used, pumps the liquid solvent 47 under pressure through a plumbing line 60, to supply to the nozzles 40. While use of a reservoir 45 is preferred, any solvent source may be used, including a pipeline connected to a separate external solvent source.

One or more heaters 50 in the solvent flow path may be used to heat the solvent. An in-line heater, or a tank heater, or both, may be used, as shown in FIG. 1. For sub-ambient applications, the heaters are replaced with chillers. For processes at ambient or room temperatures, the heater 50 can be omitted. The liquid flow path 60 may optionally include a filter 65 to filter out microscopic contaminants from the solvent.

In FIG. 1, ozone gas is generated by an ozone generator 72 and is supplied along via supply line 80, under at least nominal pressure, to the solvent flow line 70. A gas/liquid static or active mixer 90 may optionally be used to mix the ozone gas with the solvent. From the mixer 90, the process liquid comprising solvent and ozone gas is provided to the nozzles 40. The nozzles 40 spray or otherwise apply the liquid onto the surface(s) of the workpiece 20. Ozone is, released from the liquid into the processing chamber 15. Consequently, an ozone gas environment quickly forms in the chamber. As an alternative to mixing, the ozone may be entrained in the liquid, using various entrainment options, before the liquid is applied onto the workpiece 20.

At least some of the ozone gas is transported to the surface of the workpiece with the liquid. The polar characteristic of the liquid helps to weaken the chemical bonds of the molecules of the contaminant or film. This hydrolization effect renders the chemical bonds susceptible to cleavage and oxidation by the ozone gas. The contaminant is consequently oxidized and removed via chemical reactions. The liquid may optionally be forcefully sprayed or jetted onto the workpiece, to physically remove the contaminant as well. Ozone gas in the chamber may also diffuse through any solvent layer on the workpiece. A thin liquid solvent layer may be created on the wafer surface by rotating the workpiece, by controlling the flow rate of solvent, and/or by adding a surfactant to the solvent. If the thickness of the liquid solvent layer is controlled and maintained sufficiently thin, significant amounts of ozone gas in the chamber may diffuse through the layer. The diffusing ozone may also act to oxidize contaminants on the workpiece.

To further concentrate the ozone in the solvent 47, an output line 77 of the ozone generator 72 may supply ozone to a dispersion unit 95 in the reservoir 45. The dispersion unit 95 provides a dispersed flow of ozone through the solvent before injection of the ozone gas into the fluid path 60. The dispersion unit 95 may be omitted, with ozone simply bubbled into the reservoir.

In the design shown FIG. 1, used liquid in the processing chamber 15 is optionally collected and drained via a fluid line 32 to a valve 34. The valve 34 may be operated to provide the spent liquid to either a drain outlet 36 or back to the reservoir 45 via a recycle line 38. Repeated cycling of the process liquid through the system and back to the reservoir 45 assists in elevating the ozone concentration in the liquid through repeated injection and/or dispersion. The spent liquid may alternatively be directed from the processing chamber 15 to a waste drain. The workpieces may optionally be heated directly, via optional heating elements 27, or via a chamber heater 29 for heating the chamber and indirectly heating the workpiece 20.

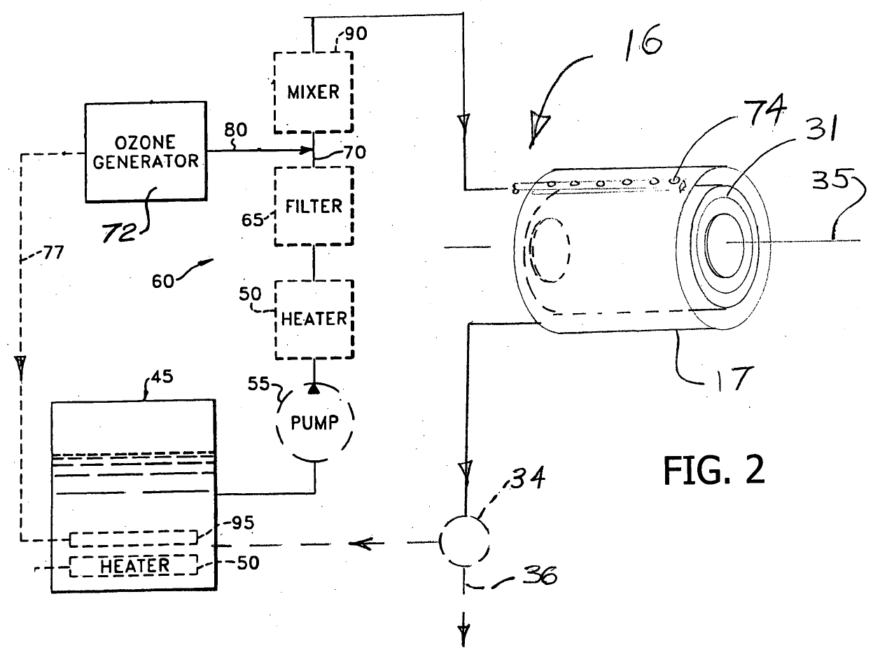

FIG. 2 shows a batch processing system 16 similar to single wafer system 14 shown in FIG. 1. In the system 16, a batch rotor 31 is enclosed within a process chamber 17 and spins about a spin axis 35. The orientation of spin axis 35 may vary, as it does not substantially affect operation of the cleaning process. The axis 35 may be near horizontal in some automated systems, to better facilitate loading and unloading of the rotor.

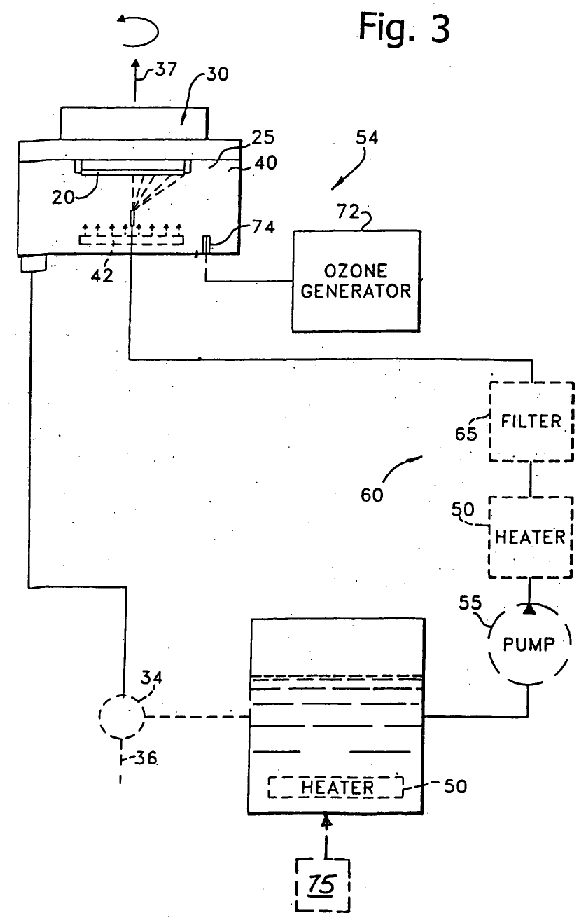

Turning to FIG. 3, in an alternative system 54, one or more nozzles 74 or openings within the processing chamber 15 deliver ozone from ozone generator 72 directly into the chamber (as a dry gas not mixed with any liquid). Additional ozone may also optionally be injected into the fluid path 60. The chamber may hold a single wafer or a batch of wafers. The system of FIG. 3 may otherwise the same as the systems of FIGS. 1 or 2 described above.

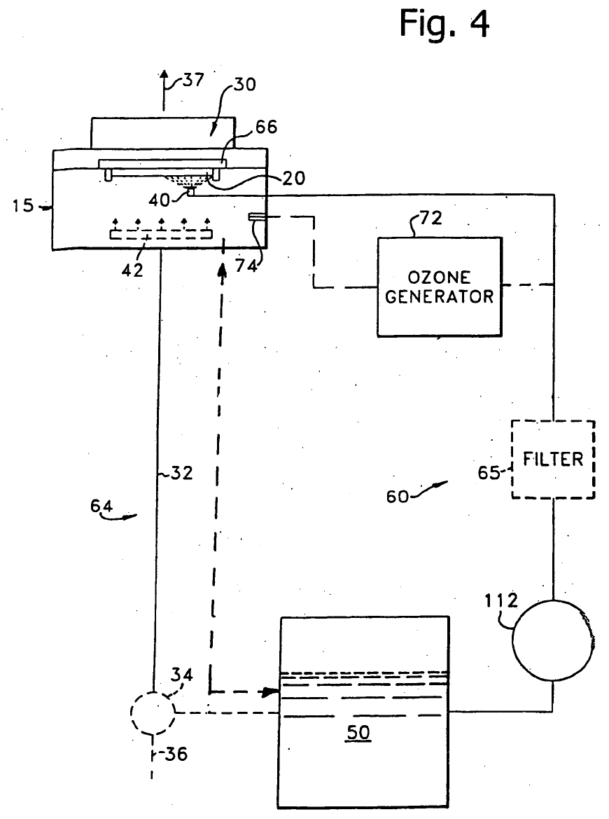

Referring to FIG. 4, in another system 64, a solvent vaporizer 112 supplies solvent vapor into the processing chamber 15. The chamber 15 is preferably sealed to form a pressurized atmosphere around the workpiece 20. Ozone may be directly injected into the processing chamber 15 as shown, and/or may be injected into the vapor supply pipe. With this design, workpiece surface temperatures can exceed 100 degree C., further accelerating the chemical reactions which clean the workpiece. While FIGS. 3 and 4 show the liquid and ozone delivered via separate nozzles 40, 74, they may also be delivered from the same nozzles, using appropriate valves.

A temperature-controlled surface or plate 66, as shown in FIG. 4, in contact with the workpiece may be provided to act as a heat sink, to maintain condensation of vapor on the workpiece. Alternatively, a stream of liquid at a temperature below the vapor condensation temperature may be delivered to the one side of a wafer 20, while vapor and ozone are delivered to the process chamber and the vapor condenses on the other side of the wafer. The wafer may be rotated to promote uniform distribution of the boundary layer, as well as to help to define the thickness of the boundary layer through centrifugal force. Rotation, however, is not a requirement.

The workpiece may be in any orientation during processing. Additives such as hydrofluoric acid, HCl, or ammonium hydroxide, may be added to promote the cleaning of the surface or the removal of specific classes of materials other than, or in addition to, organic materials. The supply of liquid, gases, and/or vapor may be continuous or pulsed.

An ultra-violet or infrared lamp 42, as shown in FIGS. 1 and 3-5, is optionally used in any of the designs described above, to irradiate the surface of the workpiece 20 during processing, and enhance the reaction kinetics. Megasonic or ultrasonic nozzles may also be used.

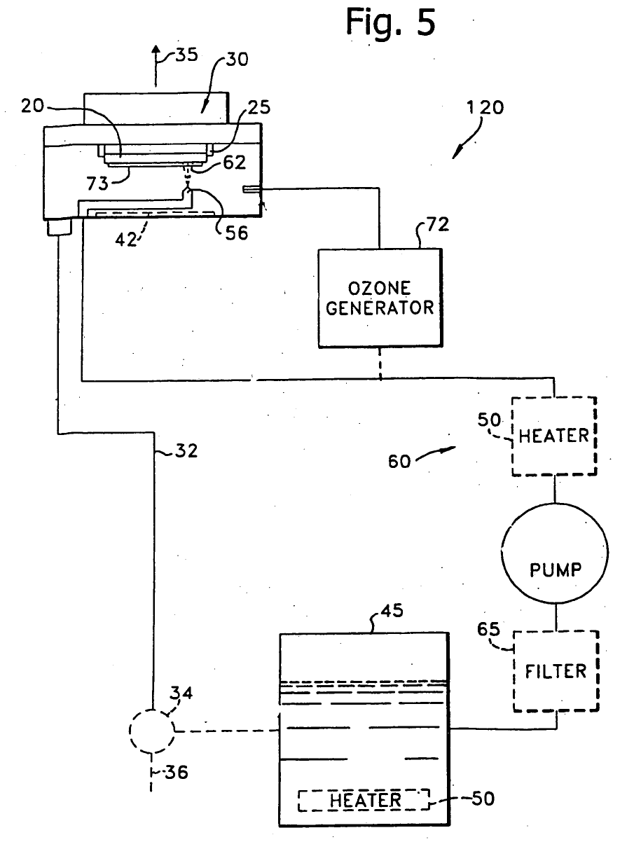

Referring to FIG. 5, another alternative system 120 is similar to the system 54 shown in FIG. 3, except that the system 120 does not use the spray nozzles 40. Rather one or more jet nozzles 56 are used to form a high pressure jet 62 of solvent. The liquid solvent formed into the high pressure jet 62 penetrates through any layer 73 of liquid solvent on the workpiece surface and impinges on the workpiece surface with much more kinetic energy than in conventional spray processes. The increased kinetic energy of the jet physically dislodges and removes contaminants. Unlike conventional fluid spray systems, few, if any, droplets are formed. Rather, a concentrated jet or beam of liquid impacts on a small spot on the workpiece 20.

Thus, while several embodiments have been shown and described, various changes and substitutions may of course be made, without departing from the spirit and scope of the invention. The invention, therefore, should not be limited, except by the following claims, and their equivalents.

1. A method for cleaning one or more workpieces having a metal area, comprising:
placing the workpiece into a processing chamber;
introducing a non-aqueous polar liquid onto the workpiece;
introducing ozone into the processing chamber;
with the ozone oxidizing contaminants on the workpiece, to clean the workpiece.

2. The method of claim 1 wherein the ozone is introduced into the processing chamber as a dry gas.

3. The method of claim 1 wherein the liquid is heated to a temperature of 30-95° C.

4. The method of claim 1 wherein the liquid comprises an organic acid, and alcohol or an aldehyde.

5. The method of claim 1 wherein the workpiece comprises a silicon wafer, and the contaminant comprises photoresist.

6. The method of claim 1 further comprising the step of rotating the workpiece within the processing chamber.

7. The method of claim 1 wherein the ozone is entrained in the liquid before the liquid is introduced onto the workpiece.

8. The method of claim 1 wherein the liquid and the ozone are introduced separately into the processing chamber.

9. The method of claim 1 wherein the liquid is sprayed onto the workpiece.

10. The method of claim 1 with the liquid further comprising an additive selected from the group consisting of HF, NH3 and carbon dioxide gas.

11. The method of claim 1 further comprising rotating a batch of workpieces in the process chamber.

12. The method of claim 1 where the metal area comprises copper or aluminum.

13. The method of claim 1 further including rinsing and drying the workpiece.

14. A method for processing a workpiece having metal on a surface of the workpiece, comprising:
forming a layer of a polar non-aqueous liquid on a surface of a workpiece;
contacting the surface of the workpiece with ozone gas in the layer of liquid, with the ozone chemically reacting with a contaminant at the surface of the workpiece.

15. The method of claim 14 further including heating the liquid.

16. The method of claim 14 further including spraying the liquid onto the surface of the workpiece and rotating the workpiece.

17. A method for cleaning one or more workpieces having one or more metal areas, comprising:
placing the workpiece into a processing chamber;
introducing a vapor of a non-aqueous polar liquid onto the workpiece, with vapor condensing on the workpiece;
introducing ozone into the processing chamber;
with the ozone oxidizing contaminants on the article, to clean the workpiece.

18. The method of claim 17 where the vapor includes an organic acid, and alcohol or an aldehyde.

19. An apparatus for cleaning a workpiece comprising:
a chamber;
a workpiece holder in the chamber;
liquid outlets in the chamber positioned to apply liquid onto at least one surface of a workpiece supported by the workpiece holder;
a source of non-aqueous polar liquid connecting with the liquid outlets;
a source of ozone gas connecting into the chamber.

20. The apparatus of claim 19 wherein the workpiece holder comprises a rotor for rotating the workpiece.

21. The apparatus of claim 19 further comprising a liquid heater for heating the liquid.

22. The apparatus of claim 19 further comprising a workpiece heater in the chamber for heating the workpiece.

23. Apparatus comprising:
(a) means for forming a layer of a non-aqueous polar liquid on the surface of a workpiece;
(b) means for supplying ozone gas to the surface of the workpiece, where the ozone oxidizes contamination on the surface to clean the workpiece.

24. The apparatus of claim 23 further including means for heating the surface of the workpiece.

25. The apparatus of claim 23 further including means for heating the non-aqueous polar liquid before supplying the liquid onto the workpiece.
